(19) United States
(12) Patent Application Publication
(10) Pub. No.: US 2004/0200515 A1
(43) Pub. Date: Oct. 14, 2004

(54) Probe pin cleaning device

(75) Inventors: Fumikazu Saito, Tokyo (JP); Katsuhide Kubo, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/802,717

(22) Filed: Mar. 18, 2004

(30) Foreign Application Priority Data
Apr. 8, 2003 (JP) 2003-104298

(51) Int. Cl. B08B 3/12

(52) U.S. Cl. 134/184; 134/201

(57) ABSTRACT

A probe pin cleaning device is generally composed of a cleaning container having a bottom-having box shape, which contains cleaning solution, a stay that is disposed on the inner bottom of this cleaning container and horizontally supports a pin board in the state where a probe pin is faced downward, an external box that has an upper opening fringe supporting the fringe of the upper opening of the above-mentioned cleaning container through a shock absorber, and an ultrasonic vibration generator.

### BACKGROUND OF THE INVENTION

1. Field of the Invention

The present invention relates to a probe pin cleaning device. More particularly, the invention relates to a non-contact type probe-pin-cleaning device that cleans a probe pin fixed in a pin board without bringing a cleaning jig in contact with the probe pin.

2. Description of the Related Art

A printed circuit board having chip components mounted thereon is inspected whether or not the circuit board has a wiring failure, mismounting of components, or defective components thereon by measuring a quantity of electricity between the terminals formed on the circuit board by using an in-circuit tester. The in-circuit tester is provided with a test jig (hereinafter referred to as a pin board) that fixes a plurality of probe pins corresponding to the terminals, respectively, formed on the printed circuit board to be inspected. This pin board holds the probe pins slidably in these longitudinal direction by use of sliding portions formed thereon corresponding to the pins, respectively. Each of the sliding portions is composed of a sleeve and a coil spring provided within the sleeve, respectively. When performing the conduction test, the pin board can put the probe pins in contact with the terminals, respectively, formed on the printed circuit board with a predetermined thrust. However, the tip of the probe pin held in the pin board can be contaminated by a foreign particle, such as flux from the printed circuit board after carrying out the conduction test.

A so-called contact-type probe-pin-cleaning device, which has been proposed in the past, has been mainly used for cleaning the probe pin. This probe pin cleaning device uses a brush that directly cleans the stylus portion of the probe pin. For example, Japanese Patent Publication JP-A 5-281257 (claim 1 and FIG. 1) discloses a contact-type probe-pin-cleaning device using the brush. However, the brush of this probe pin cleaning device would exert a large external force on the probe pin. Thereby, the probe pin may be damaged due to deformation.

Meanwhile, a non-contact type probe-pin-cleaning device is known. For example, Japanese Patent Publication JP-A 8-290090 (claim 1 and FIG. 4) discloses a non-contact-type probe-pin-cleaning device. The device jets a cleaning solution dissolving the foreign particle adhering to the stylus portion of the probe pin and cleaning air on the stylus portion of the probe pin from above, and thereby cleans the pin. The probe pin is fixed facing upward in the pin board. This cleaning device slightly deforms and damages the probe pin.

Further, for example, Japanese Patent Publication JP-A 5-264588 (claim 1 and FIG. 1) discloses a pin board that applies a static thrust and ultrasonic vibration to the stylus portion of the probe pin, and thereby makes the pin come in contact with and conduct electricity to the terminal. The object of this pin board is to stably perform the conduction test on the printed circuit board even if the circuit board has not been flux cleaned. However, when the probe pin fixed in this pin board got soiled by a foreign particle, it is necessary to clean this probe pin by use of the above-described probe pin cleaning device that has been proposed in the past.

However, because the probe pin cleaning devices known to the inventor are arranged as mentioned above, there have been the following problems.

That is, in the existing non-contact-type probe-pin-cleaning device, the cleaning solution jetted to the probe pin mounted facing upward goes down along the probe pin to enter the sliding portion of the pin board, and can corrode the coil spring placed within the sliding portion. In this case, the probe pin to be slid by the coil spring cannot slidingly travel a predetermined distance because of the coil spring corrosion. Therefore, there is a problem that the probe pin makes poor contact with the terminal of the printed circuit board, and thereby a precise conduction test cannot be performed. Moreover, there is a problem that when isopropyl alcohol (IPA) or glycol ether (GE), for example, is used as the cleaning solution, the solvent handling is difficult, the availability of the solvents is limited, and further the damage such as the crack of the pin board (hereinafter referred to as the solvent crack) is caused because of the penetration of the solvents into the board. Furthermore, there is a problem that the device becomes very large because the device requires a jetting mechanism jetting the cleaning solution and a jetting mechanism jetting the cleaning air individually. Additionally, when the existing probe pin cleaning device is used, the user checks whether or not the foreign particles are removed from the pins by directly inspecting the minute probe pins visually or by using a unit such as a magnifying lens. Therefore, there is a problem that confirming the cleaning completion takes much time.

### SUMMARY OF THE INVENTION

The present invention has been accomplished to solve the above-mentioned problems. An object of the present invention is to provide a small probe-pin-cleaning device that reliably cleans only the stylus portion of the probe pin without causing a trouble, such as a solvent crack produced in the pin board fixing the probe pin after cleaning the probe pin. Furthermore, when the device is used, the cleaning state of the probe pin can be easily checked.

A probe pin cleaning device according to one aspect of the present invention is constituted to include a fixing member for fixing uprightly a probe pin; a supporting member for supporting the fixing member; a cleaning container for containing a cleaning solution; and an ultrasonic vibration generating means for generating ultrasonic vibrations directed to the cleaning solution in which the stylus portion of a probe pin facing downward is immersed.

Therefore, according to one aspect of the present invention, only the stylus portion of the probe pin can be surely efficiently cleaned by use of the ultrasonic vibration transmitted to the stylus portion of the probe pin through the medium of the cleaning solution. At the same time, because there is no cleaning solution that flows along the probe pin and goes to the pin board fixing the probe pin, the occurrence of the trouble, such as the solvent crack, which is caused in the pin board after the cleaning was carried out by using the existing cleaning device, can be surely prevented. Moreover, according to the present invention, since the jetting mechanisms that jet the cleaning solution and the cleaning air which have been employed in the existing cleaning device become unnecessary, the cleaning device can be made compact.

### BRIEF DESCRIPTION OF THE DRAWINGS

FIG. 1 is a fragmentary sectional view of the configuration of a probe pin cleaning device according to a first embodiment of the present invention;

FIG. 2 is an elevation view of an ultraviolet irradiating mechanism that is used for irradiating the probe pin to be cleaned by the probe pin cleaning device shown in FIG. 1, with ultraviolet rays, and that has a body separated from the cleaning device;

FIG. 3 is a fragmentary sectional view of the configuration of a probe pin cleaning device according to a second embodiment of the present invention;

FIG. 4 is a fragmentary sectional view of the configuration of an automatic probe pin cleaning device according to a third embodiment of the present invention; and

FIG. 5 is a flow chart for giving the description of the operation of the automatic probe-pin-cleaning device shown in FIG. 4.

### DETAILED DESCRIPTION OF THE PREFERRED EMBODIMENTS

An embodiment of the present invention will be described below.

### First Embodiment

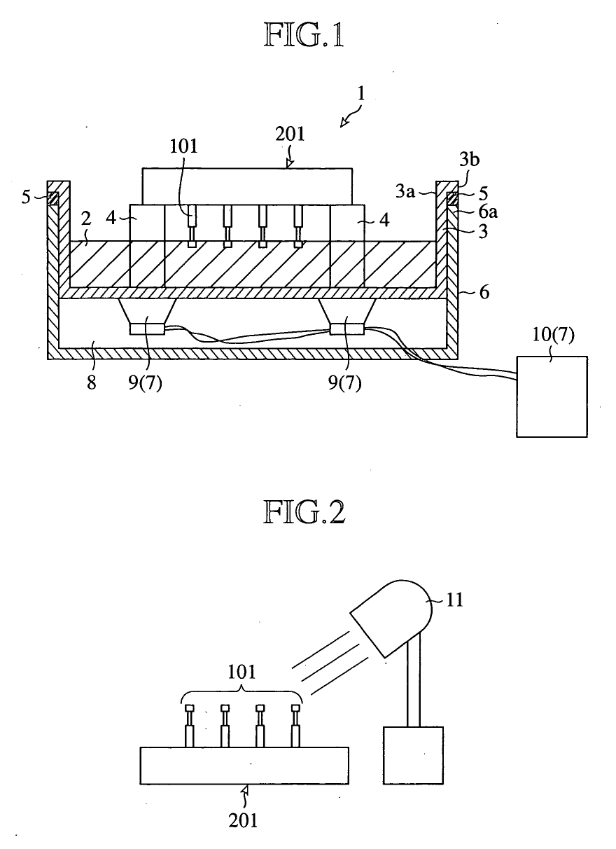

FIG. 1 is a fragmentary sectional view of the configuration of a probe pin cleaning device according to a first embodiment of the present invention, and FIG. 2 is an elevation view of an ultraviolet irradiating mechanism that is used for irradiating the probe pin to be cleaned by the probe pin cleaning device shown in FIG. 1, with ultraviolet rays, and that has a body separated from the cleaning device.

Referring to FIG. 1, a probe pin cleaning device 1 is a cleaning device that can ultrasonically clean stylus portions which are respectively located on the tips of a plurality of probe pins (PP) 101 that are uprightly fixed while facing downward on a pin board (PB) 201 as a fixing member. The device 1 may be generally composed of a cleaning container 3 in a bottomed-box shape, which contains cleaning solution 2, a stay (supporting member) 4 that is disposed on the inner bottom of this cleaning container 3, and horizontally supports the pin board 201 in the state where the probe pins 101 are faced downward, an external box 6 having an upper opening fringe 6a that supports the fringe 3b of the upper opening 3a of the above-mentioned cleaning container 3 through a shock absorber 5, and an ultrasonic vibration generator (ultrasonic vibration generating means) 7. The ultrasonic vibration generator 7 may be generally composed of: a vibrator 9 that is provided within an internal room 8 formed between the bottom of the cleaning container 3 and the bottom of the external box 6, and secured to the outer bottom of the cleaning container 3; and an oscillator 10 that is electrically connected with this vibrator 9 and placed outside the external box 6. The oscillator 10 can oscillate the vibrator 9, and thereby apply ultrasonic vibration to the cleaning solution 2 through the cleaning container 3. Moreover, the oscillator 10 can output the ultrasonic vibration periodically or in the mode in which the frequency or amplitude is changed. The vibration mode can be suitably changed depending on the contamination condition of the probe pin 101.

A solution that includes ethyl alcohol (hereinafter referred to as ethanol) can be preferably used as the cleaning solution 2. Ethanol is more available and less harmful to the human body and the environment than IPA or GE, which has been used as the existing cleaning solution. Ethanol has high cleaning ability and suitable volatility. The cleaning solution 2 can include ethanol, but is not limited to the solution including ethanol. Any cleaning solution having cleaning ability, low toxicity, and volatility that are equivalent to the ones of the solution including ethanol can be used as the cleaning solution. The ethanol concentration may be properly determined depending on factors, such as the contamination condition of the probe pin 101 to be cleaned, the volatility of the solution, and the economy of the solution. The cleaning container 3 may be made of any material compatible with the solution having the ethanol concentration used in the cleaning solution 2, such as stainless steel. Moreover, the upper opening 3a of the cleaning container 3 may be arranged to have the size and shape such that the container can contain the pin board 201 as it is. Therefore, the stylus portions of the plurality of probe pins 101 fixed in this pin board 201 can be simultaneously efficiently cleaned without detaching the probe pins 101 from the pin board 201.

The stay 4 can have the height balancing the gap between the height of the stylus portion of the probe pin 101 having a length that varies from one pin board 201 fixing the pin 101 to another and the height of the solution surface of the cleaning solution 2 so that only the stylus portion of the probe pin 101 mounted on the pin board 201 that is supported on the stay 4 can be immersed in the cleaning solution 2 contained in the cleaning container 3. A stay 4 having the length specifically adjusted for each individual pin board 201 to be cleaned can be prepared.

The shock absorber 5 may be a generally ring-shaped component that is placed on and along the upper opening fringe 6a of the external box 6. This shock absorber 5 may be made of any material having sufficient elasticity for efficiently vibrating only the cleaning container 3 by the ultrasonic vibration and intercepting the transmission of the ultrasonic vibration from the cleaning container 3 to the external box 6, and sufficient durability for enduring the ultrasonic vibration. For example, elastic material such as rubber can be preferably employed for the absorber. When this probe pin cleaning device 1 is installed, the disposition of this shock absorber 5 can eliminate the influence of the ultrasonic vibration on its surroundings.

The probe pin cleaning device 1 having such a configuration may be equipped with a backlight apparatus (ultraviolet irradiating means) 11 and an air blowing mechanism (or a blower) (not shown), both separated from the device. The backlight apparatus 11 can serve as the apparatus by which the presence or absence of a foreign particle adhering to the stylus portion of the probe pin 101 is checked by irradiating the probe pin 101 with ultraviolet rays before and after cleaning the probe pin. In such a way, the user can easily visually confirm the presence or absence of a foreign particle that reflects the ultraviolet rays and thereby whitely shines. Here, “visually” does not mean that the user observes the foreign particle with naked-eyes, but means that the user does necessarily through use of an ultraviolet-ray-removing filter. In addition, the probe pin cleaning device 1 may be equipped with a driving power supply (not shown) that energizes the ultrasonic vibration generator 7, the backlight apparatus 11, and the blower (not shown). It is assumed that each of the apparatus, means and mechanisms is in the state where they can be driven by the driving power supply (not shown) in the following description of the operation of the probe pin cleaning device.

The operation will now be described as below.

The probe pin 101 fixed in the pin board 201 to be cleaned is first irradiated with ultraviolet rays from the backlight apparatus 11 as shown in FIG. 2. In such a way, the presence or absence of a foreign particle adhering to the stylus portion of the probe pin 101 can be visually confirmed. Then, as shown in FIG. 1, the stay 4 is placed at the inner bottom of the cleaning container 3. The stay 4 may have the height specifically adjusted for the thickness of the above-mentioned pin board 201. After that, a certain amount of the cleaning solution 2 is poured in the cleaning container 3 to become a predetermined depth. The solution may be a solution including ethanol in a predetermined amount or any other suitable material in a predetermined amount.

Then, the pin board 201 is mounted upside down on the stay 4 so that the probe pin 101 of the board 201 is faced downward. Thus, the stylus portion of the probe pin 101 is immersed in the cleaning solution 2 to a predetermined depth. For example, the predetermined depth is preferably 1 mm. After that, the cleaning container 3 is placed on the upper portion of the external box 6 through the medium of the shock absorber 5. Alternatively, the cleaning container 3 is first placed on the upper portion of the external box 6 through the shock absorber 5. Then, the stay 4 is placed on the inner bottom of the cleaning container 3, and the cleaning solution 2 is poured into the cleaning container 3. After that, the pin board 201 may be mounted upside down on the stay 4, thus immersing the stylus portion of the probe pin 101 in the cleaning solution 2.

Next, the oscillator 10 of the ultrasonic vibration generator 7 is driven, and the ultrasonic vibration generated from the vibrator 9 is applied to the cleaning solution 2 through the cleaning container 3. Thus, the cleaning of the probe pin 101 stylus will be started. Then, after a predetermined time passed, the drive of the ultrasonic vibration generator 7 is stopped. The pin board 201 fixing the probe pin 101 is moved from the cleaning container 3, and the cleaning solution 2 deposited on the probe pin 101 is vaporized. At that time, the solution may be vaporized therefrom by use of the wind from the blower, if necessary (not shown). The pin board 201 fixing the probe pin 101 is placed so that the probe pin 101 is faced upward. Then, the removal condition of the foreign particle adhering to the stylus portion of the probe pin 101 can be observed in any suitable manner. For example, the removal condition may be visually observed by irradiating the stylus portion with the ultraviolet rays from the backlight apparatus 11 as shown in FIG.2. When it is confirmed that the foreign particle has been completely removed, the pin board 201 can be reused for the conduction test of devices, such as a printed circuit board (not shown).

As mentioned above, the probe pin cleaning device according to the first embodiment is constituted to include the ultrasonic vibration generator 7 that can generate ultrasonic vibration directed to the cleaning solution 2 in which the stylus portion of the probe pin 101 facing downward is immersed. In such a way, only the stylus portion of the probe pin 101 can be surely efficiently cleaned by the ultrasonic vibration transmitted to the stylus portion of the probe pin 101 through the medium of cleaning solution 2. At the same time, because there is no cleaning solution 2 that flows along the probe pin 101 and goes to the pin board 201, the occurrence of troubles such as the solvent crack that may be caused in the pin board 201 after the cleaning device proposed in the past is used can be surely prevented. Moreover, according to the first embodiment, the jetting mechanisms that jet the cleaning solution and cleaning air conventionally employed become unnecessary. Accordingly, the cleaning device can be made compact.

According to the first embodiment, the probe pin cleaning device is constituted to include ethanol as the cleaning solution 2. Therefore, it is possible to more easily obtain the cleaning solution, lower the influence on the human body and environment, increase the cleaning ability, and more easily dry the probe pin 101 because of its excellent volatility as compared with IPA or GE that has been used as the cleaning solution in the past.

According to the first embodiment, the cleaning device is constituted to have the backlight apparatus 11 by which the stylus portion of the probe pin 101 is irradiated with ultraviolet rays, and thereby the presence or absence of the foreign particle adhering to the stylus portion can be visually confirmed. Accordingly, the user can easily visually confirm the presence or absence of the foreign particle reflecting the ultraviolet rays and thereby whitely shining by means of irradiating the probe pin 101 with ultraviolet rays before and after cleaning of the probe pin 101.

### Second Embodiment

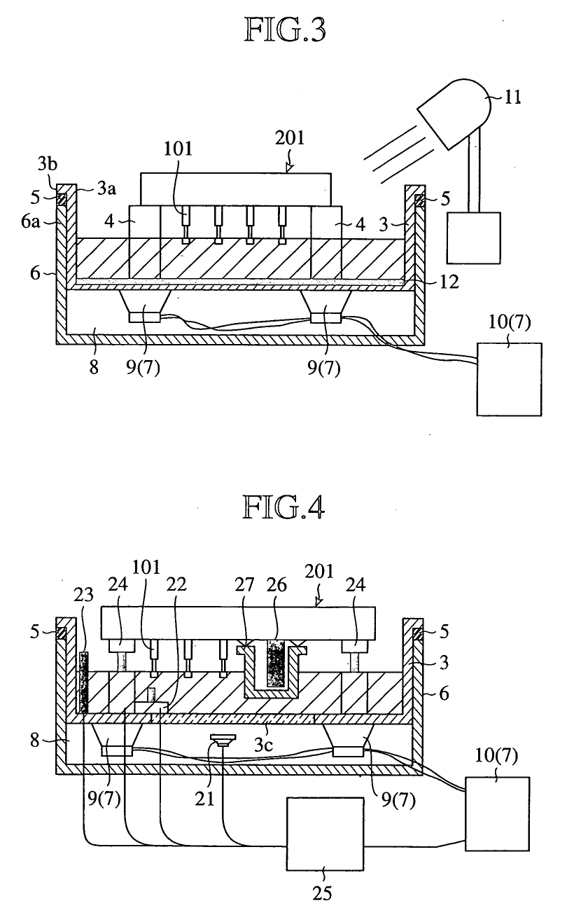

FIG. 3 is a fragmentary sectional view of the configuration of a probe pin cleaning device according to a second embodiment of the present invention. Of the constituent elements used in the second embodiment, the constituent elements that are common to the ones used in the first embodiment are designated by similar numerals. The explanation of the elements is omitted.

It has been found that particularly good results are obtained if a reflection mirror 12 that reflects the ultraviolet rays from the backlight apparatus 11 and applies the rays to the stylus portion of the probe pin 101 is provided over the inner bottom of the cleaning container 3. According to the second embodiment, the backlight apparatus 11 can be disposed obliquely above the cleaning container 3 so that the ultraviolet rays can be applied to the reflection mirror 12 provided within the cleaning container 3, obliquely from above the upper opening 3a of the cleaning container 3. Additionally, when the interior of the cleaning container 3 is made of material transmitting ultraviolet rays, the reflection mirror 12 can be provided over the outer bottom of the cleaning container 3.

The operation will now be described as below.

As shown in FIG. 3, the stay 4 dedicated to the pin board 201 is first placed on the reflection mirror 12 provided over the inner bottom of the cleaning container 3. After that, the cleaning solution 2 is poured with a predetermined amount within the cleaning container 3 to become a predetermined depth. Note that the solution can include ethanol or any other suitable material.

Then, the pin board 201 is mounted upside down on the stay 4 so that the probe pin 101 fixed in the board 201 is faced downward. Next, the stylus portion of the probe pin 101 is immersed in the cleaning solution 2 to a predetermined depth. For example, the predetermined depth may be 1 mm. After that, the cleaning container 3 is placed on the upper portion of the external box 6 through the shock absorber 5. Alternatively, the cleaning container 3 is placed on the upper portion of the external box 6 through the shock absorber 5. Then, the stay 4 is placed on the inner bottom of the cleaning container 3. Subsequently, the cleaning solution 2 is poured into the cleaning container 3. After that, the pin board 201 may be placed upside down on the stay 4, thus immersing the stylus portion of the probe pin 101 in the cleaning solution 2.

Next, the backlight apparatus 11 is lit, and the ultraviolet rays therefrom is applied to the reflection mirror 12 installed over the inner bottom of the cleaning container 3. While visually observing the foreign particle that is whitely shining because of the irradiation of ultraviolet rays, adhering to the stylus portion of the probe pin 101, the oscillator 10 of the ultrasonic vibration generator 7 is driven, and thereby the ultrasonic vibration generated from the vibrator 9 is applied to the cleaning solution 2 through the cleaning container 3. Thereby, the cleaning of the stylus portion of the probe pin 101 is started. Then, when the foreign particles are not completely removed even though a predetermined time has passed, the cleaning time can be extended in case of necessity. Then, when it is confirmed that the foreign particles are completely removed, the backlight apparatus 11 is turned off, and the drive of the ultrasonic vibration generator 7 is stopped. After that, the pin board 201 fixing the probe pin 101 is moved from the cleaning container 3, and the cleaning solution 2 deposited on the probe pin 101 can be vaporized. At that time, the solution 2 may be vaporized therefrom by use of the wind from the blower, if necessary (not shown). In such a way, the pin board 201 can be reused for a conduction test for devices such as a printed circuit board (not shown).

As mentioned above, according to the second embodiment, it is constituted, in addition to the configuration in the first embodiment, that the reflection mirror 12 that reflects the ultraviolet rays from backlight apparatus 11 and applies the rays to the stylus portion of the probe pin 101 be provided over the inner bottom of the cleaning container 3. In such a way, while observing the removal condition of the foreign particle adhering to the stylus portion of the probe pin 101, namely, the cleaning level, the user can drive the ultrasonic vibration generator 7, and make the generator generate ultrasonic vibration, thereby cleaning only the stylus portion of the probe pin 101 by use of the vibration. In the first embodiment, the user could detach the pin board 201 of the probe pin 101 from the probe pin cleaning device 1, and then could confirm the cleaning level of the stylus portion of probe pin 101. However, in the second embodiment, the user can perform clean the probe pin in a further shortened time with a higher degree of efficiency.

### Third Embodiment

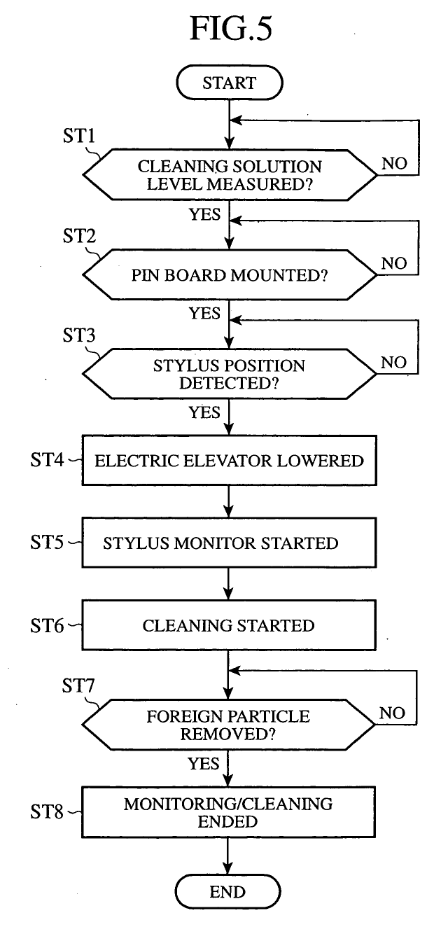

FIG. 4 is a fragmentary sectional view showing the configuration of an automatic probe pin cleaning device according to a third embodiment of the present invention, and FIG. 5 is a flow chart for giving the description of the operation of the automatic probe pin cleaning device shown in FIG. 4. Of the constituent elements used in the third embodiment, the constituent elements that are common to the ones used in the first embodiment are designated by similar numerals. The explanation of the elements is omitted.

It has been found that particularly good results are obtained if the ultrasonic cleaning to the stylus portion of the probe pin 101 is automatically performed. That is, as shown in FIG. 4, a black light transmission region 3c is formed in the bottom of the cleaning container 3 in an automatic probe pin cleaning device 20. Further, the internal room 8 is equipped with an image recognition camera 21 having a black light illuminating function under the black light transmission region 3c.

The image recognition camera 21 can include a mechanism that selectively sequentially observes the stylus portion of at least one probe pin 101 among a plurality of probe pins 101 fixed in the pin board 201 mounted on the cleaning container 3 while irradiating the stylus portion with ultraviolet radiation. Moreover, on the inner bottom of the cleaning container 3 can be provided a stylus position detecting sensor 22, a level meter 23, and an electric elevator 24. The stylus position detecting sensor 22 can detect the positions of the stylus portions of the probe pins 101 other than the probe pin 101 to be observed by the above-mentioned image recognition camera 21. The level meter 23 can detect the level of the cleaning solution 2 poured in the cleaning container 3. The electric elevator (elevating means) 24 can horizontally raise or lower the pin board 201 so that the positions (heights) of the stylus portions of the probe pins 101 can be changed with respect to the level of the cleaning solution 2.

Electrically connected with a computer 25 may be each of the image recognition camera 21, the stylus position detecting sensor 22, the level meter 23, the electric elevator 24, and the oscillator 10 of the ultrasonic vibration generator 7. Accordingly, the computer 25 can control the drive of the electric elevator 24 and the ultrasonic vibration generator 7 depending on the information from the image recognition camera 21, the stylus position detecting sensor 22, and the level meter 23. To be more specific, the computer 25 can constitute an image recognizing mechanism or means in cooperation with the image recognition camera 21. The image recognizing mechanism can know the cleaning level of the stylus portion of the probe pin 101 by analyzing the image information on the stylus portion of the probe pin 101 from the image recognition camera 21.

Moreover, the computer 25 can constitute a checking mechanism in cooperate with the stylus position detecting sensor 22 and the level meter 23. The checking mechanism can check whether or not the stylus portion of the probe pin 101 is immersed in the cleaning solution 2 by analyzing the position information on the stylus portion of the probe pin 101 from the stylus position detecting sensor 22 and the level information on the cleaning solution 2 from the level meter 23. Further, the top of the electric elevator 24 can be provided with a weight sensor (not shown) that determines whether or not the pin board 201 is placed thereon.

The black light transmission region 3c can preferably use glass for its material, but the material is not limited to glass. The black light transmission region 3c may be made of any other material that has transmittance and mechanical strength that are comparable to that of glass.

The electric elevator 24 can include any raising and lowering mechanism that can electrically time the start and stop of raising or lowering the pin board 201 by the command of the computer 25, and can raise or lower the pin board 201 precisely, for example, in millimeter unit.

In addition, when the pin board 201 has a non-contacted component 26 that is not to be contacted with the cleaning solution 2, such as ethanol, the pin board 201 can have a projecting cover 27 covering the non-contacted component 26, for example, as shown in FIG. 4. For example, the projecting cover may be removably attached thereto in a snap-fit structure or in any other desired manner.

The operation will now be described as below.

Before starting the cleaning, the electric elevator 24 is first stopped at the position where the stylus portion of the probe pin 101 is not immersed in the cleaning solution 2 (hereinafter referred to as the upper position). The amount of the cleaning solution 2 is determined so that the stylus portion of the probe pin 101 is not immersed in the cleaning solution 2 when the pin board 201 is mounted upside down on the electric elevator 24. In this state, the level meter 23 can accurately measure the level of the cleaning solution 2 in the cleaning container 3 (step ST1). When the level of the solution is detected, the level information is sent to and stored in the computer 25.

Then, a weight sensor (not shown) checks whether or not the pin board 201 is mounted on the electric elevator 24 (step ST2). When the pin board 201 is mounted on the electric elevator 24, the checked information is transmitted to the computer 25. This information transmission becomes a trigger, and the stylus position detecting sensor 22 detects the position of the stylus portion of the pin board 201 mounted on the electric elevator 24 (step ST3). When this stylus position detecting information is sent to the computer 25, the computer 25 determines the position at which only the stylus portion of the probe pin 101 is immersed in the cleaning solution 2 (hereinafter referred to as the lower position) on the basis of the stylus position detection information and the above-mentioned level information, and lowers the electric elevator 24 to the lower position (step ST4).

Then, in the state where the stylus portion of the probe pin 101 is being immersed in the cleaning solution 2, the backlight function of the image recognition camera 21 applies ultraviolet rays to the stylus portion of the probe pin 101 through the black light transmission region 3c, and at the same time the image recognition camera 21 monitors the stylus portion of the probe pin 101 in the state the cleaning is not yet started (step ST5). This image information can be successively sent to the computer 25 as the information indicating the contaminating condition of the stylus portion of the probe pin 101.

Then, the oscillator 10 of the ultrasonic vibration generator 7 is driven, and the vibrator 9 generates ultrasonic vibration to the cleaning solution 2 through the cleaning container 3. Thus, the cleaning of the stylus portion of the probe pin 101 is started (step ST6). Then, on the basis of the image information monitored by the image recognition camera 21, the computer 25 determines whether or not the foreign particle of the stylus portion of the probe pin 101 is completely removed (step ST7). When determined that the foreign particle is completely taken off, the operation of the image recognition camera 21 and the drive of the ultrasonic vibration generator 7 is stopped, and the cleaning is ended (step ST8).

Then, the pin board 201 is detached in the state where the electric elevator 24 is being held in the upper position. Then, the blower (not shown) winds the probe pin 101 fixed on the pin board 201, if necessary, thereby vaporizing the cleaning solution 2 deposited thereon. In such a way, the pin board 201 can be reused for the conduction test of devices such as a printed circuit board (not shown).

As mentioned above, according to the third embodiment, the probe pin cleaning device is constituted to include the image recognition camera 21 and the computer 25 as an image recognizing means that can observe the foreign particle on the probe pin 101 by recognizing the image of the stylus portion of the probe pin 101 which is irradiated with ultraviolet radiation, in addition to the ultrasonic vibration generator 7. Thereby, the probe pin cleaning device can ultrasonically clean the stylus portion of the probe pin 101 while monitoring the cleaning level of the stylus portion of the probe pin 101. Accordingly, the cleaning time can be controlled, and the cleaning of the stylus portion of the probe pin 101 can be automated.

According to the third embodiment, the probe pin cleaning device is constituted to include the stylus position detecting sensor 22, the level meter 23, and the computer 25 as a detecting unit that can check whether or not the stylus portion of the probe pin 101 fixed on the pin board 201 is immersed in the cleaning solution 2, and the electric elevator (elevating means) 24 that can change the position of the position of the stylus portion of the probe pin 101 with respect to the level of the cleaning solution 2 on the basis of the detection information obtained by this detecting unit. For this reason, when the user simply mounts the pin board 201 on the electric elevator 24, the pin board 201 can be automatically raised or lowered so that only the stylus portion of the probe pin 101 can be immersed in the cleaning solution 2, thereby automating the preparation process before starting the cleaning process.

What is claimed is:

1. A probe pin cleaning device comprising:
a fixing member for fixing uprightly a probe pin;
a supporting member for supporting the fixing member;
a cleaning container for containing a cleaning solution; and
an ultrasonic vibration generating means for generating ultrasonic vibrations directed to the cleaning solution in which the stylus portion of the probe pin facing downward is immersed.

2. The probe pin cleaning device according to claim 1, wherein the cleaning solution includes ethyl alcohol.

3. The probe pin cleaning device according to claim 2, comprising an ultraviolet irradiating means for irradiating the stylus portion of the probe pin with ultraviolet rays for detecting the presence or absence of a foreign particle on the portion.

4. The probe pin cleaning device according to claim 3, comprising a reflective mirror that is provided on the bottom of the cleaning container containing the cleaning solution, reflects the ultraviolet rays from the ultraviolet irradiating means, and applies the rays to the stylus portion of the probe pin.

5. The probe pin cleaning device according to claim 3, comprising an image recognizing means for recognizing the image of the stylus portion of the probe pin which is irradiated with the ultraviolet rays, and thereby detects the presence or absence of a foreign particle on the probe pin.

6. The probe pin cleaning device according to claim 5, comprising:
a checking means for checking whether or not the stylus portion of the probe pin fixed on the fixing member is immersed in the cleaning solution; and
an elevating means for changing the position of the stylus portion of the probe pin with respect to the level of the cleaning solution depending on the checking information given by the checking means.
